(19) United States
(12) Patent Application Publication
(10) Pub. No.: US 2006/0114286 A1
(43) Pub. Date: Jun. 1, 2006

(54) Inkjet printer

(75) Inventor: Gu-hwan Na, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/212,735

(22) Filed: Aug. 29, 2005

(30) Foreign Application Priority Data
Nov. 27, 2004 (KR) 10-2004-0098358

(51) Int. Cl. B41J 2/165

(52) U.S. Cl. 347/33

(57) ABSTRACT

An inkjet printer includes a printing head with a length that corresponds to a width of a sheet of paper being printed upon. The printing head has a nozzle unit, and the nozzle unit has a plurality of nozzle plates. A cleaning device slides in a lengthwise direction of the printing head and forcibly absorbs and removes foreign matter stuck to the nozzle plates.

### CROSS-REFERENCE TO RELATED APPLICATIONS

This application claims the benefit under 35 U.S.C. § 119(a) of Korean Patent Application No. 10-2004-0098358, filed on Nov. 27, 2004, in the Korean Intellectual Property Office, the entire disclosure of which is hereby incorporated by reference.

### BACKGROUND OF THE INVENTION

1. Field of the Invention

The present invention relates to an inkjet printer. More particularly, the present invention relates to an inkjet printer that includes a cleaning device that cleans nozzles.

2. Description of the Related Art

Generally, an inkjet printer forms an image by ejecting droplets of ink through a printing head disposed at a predetermined height above a top surface of a sheet of paper. The printing head shuttles in a direction perpendicular to the direction that the paper moves.

The printing head includes a nozzle unit having a plurality of nozzles that eject ink. After ink is ejected onto a sheet of paper from the nozzles, droplets of ink that are not ejected onto the sheet of paper remain around the nozzles. Such droplets of ink may increase in size due to repeated ejections of ink and may drop at undesired positions. In addition, as the droplets of ink dry, dust in the air attaches to the droplets of ink, which in turn become solid deposits. Thus, a portion of the nozzles is clogged with these solid deposits, thereby distorting the direction that ink is ejected. Consequently, the printing process deteriorates and a poor image is formed.

To solve this problem, various apparatuses for wiping the droplets of ink that remain around nozzles have been proposed. Examples of such apparatuses are disclosed in Japanese Laid-open Patent Publication Nos. 2-113949, 5-092576, 11-254692, and 15-063021, each of which is hereby incorporated by reference in its entirety.

These apparatuses include wipers that are slightly longer than a nozzle unit, which is usually less than one inch long in the width direction of a sheet of paper. To wipe the nozzle unit, the apparatuses shuttle the wipers in a paper moving direction or move the wipers once or twice in the same direction. The wipers rub the nozzle unit, thereby wiping droplets of ink, solidified ink, and dust from the nozzle unit.

Recently, there have been attempts to replace a conventional printing head which shuttles in the width direction of a sheet of paper with a printing head including a nozzle unit having a length corresponding to a width of a sheet of paper to facilitate high-speed printing. In such a device, the printing head is usually stationary while a sheet of paper is moved. Therefore, the driving mechanism of an inkjet printer with such a printing head has a simple structure, and the ink jet printer can print at high speeds. A nozzle unit of such an inkjet printer may be 210 mm long to correspond to, for example, A4-size paper (without considering any printing margins in the width direction of a sheet of paper).

An apparatus for wiping droplets of ink that remain around the nozzles of an inkjet printer is disclosed in U.S. Pat. No. 6,637,856, which is incorporated by reference in its entirety. The apparatus includes a cleaning roller that rotates in contact with the bottom surfaces of a nozzle unit. As the cleaning roller rotates in a width direction of the nozzle unit, the cleaning roller removes solidified ink and foreign matter that remain around the nozzle unit.

When the nozzle unit ejects color ink, the cleaning roller must clean off the residues of each color of ink of the nozzle unit while rotating at intervals equal to the respective widths of the nozzles for printing the individual colors (typically, cyan, magenta, yellow, and black) of the nozzle unit. However, if the widths of the nozzles for each color of the nozzle unit are too narrow, it is difficult for the cleaning roller to absorb each color ink separately. Thus, when cleaning off a second color ink after cleaning off a first color ink, the cleaning roller may contaminate the second color ink with the previous color ink. In other words, since a plurality of colors of ink are cleaned off using one cleaning roller, the color inks may be contaminated.

Accordingly, there is a need for an improved inkjet printer with a cleaning device capable of cleaning a printing head that includes a nozzle unit having a length corresponding to a width of a sheet of paper without contaminating different colors of ink.

### SUMMARY OF THE INVENTION

An aspect of the present invention is to solve at least the above problems and/or disadvantages and to provide at least the advantages described below. Accordingly, an aspect of the present invention is to provide an inkjet printer that includes a cleaning device capable of cleaning a printing head that includes a nozzle unit having a length corresponding to a width of a sheet of paper.

According to an aspect of the present invention, an inkjet printer includes a printing head and a cleaning device. The printing head has a length that corresponds to a width of a sheet of paper and includes a nozzle unit having a plurality of nozzle plates. The cleaning device slides in a lengthwise direction of the printing head and forcibly absorbs and removes foreign matter stuck to the nozzle plates.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a schematic perspective view of an inkjet printer including a cleaning device according to the present invention;

FIG. 2 is a sectional view of the inkjet printer taken along line I-I′ of FIG. 1;

FIG. 3 is a perspective view of the cleaning device divided into two parts according to the present invention; and

FIG. 4 is a front view of the inkjet printer for explaining the operation of the cleaning device according to the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

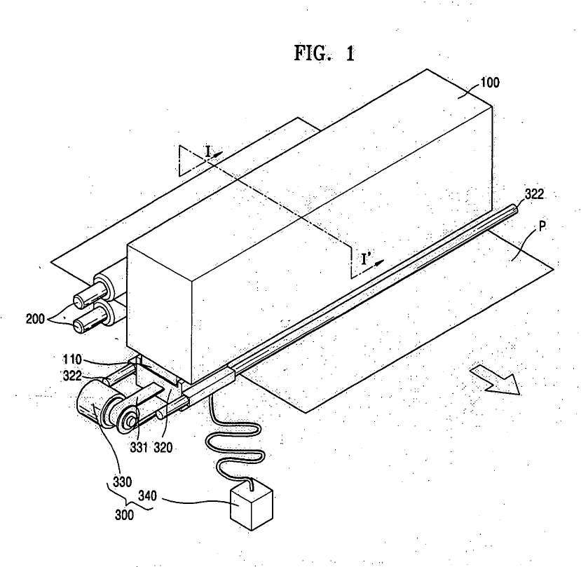

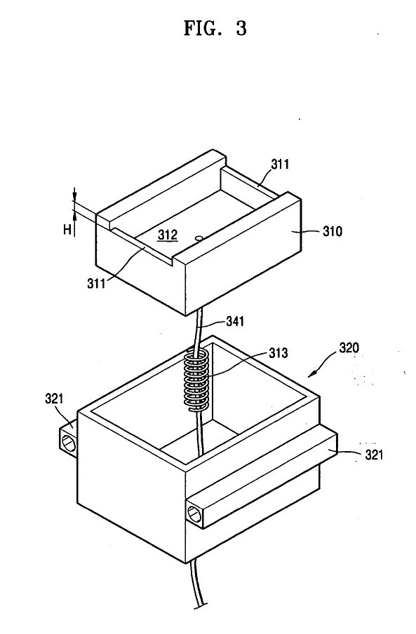

Referring to FIGS. 1 through 3, an inkjet printer includes a printing head 100, a nozzle unit 110, a pair of conveying rollers 200, and a cleaning device 300. The printing head 100 includes the nozzle unit 110 having a plurality of nozzle plates 111. The nozzle unit 110 has a length corresponding to a width of a sheet of paper P. While rotating, the conveying rollers 200 convey the sheet of paper P passed therebetween to the nozzle unit 110. The cleaning unit 300 disposed in the lower part of the printing head 100 cleans off droplets of ink that remain in the nozzle unit 110.

The cleaning device 300 includes an absorber 310, a moving body 320, a driving unit 330, and a suction unit 340. The absorber 310 encloses and seals the nozzle plates 111 and includes, on both sides of the absorber 310, grooves 311 that are cut into the absorber 310 by a height H equal to a height h by which the nozzle plates 111 protrude from the nozzle unit 110. Therefore, the nozzle plates 111 can be easily inserted into the absorber 310 and are sealed from their surroundings. The nozzle plates 111 may protrude from the nozzle unit 110 by various heights other than the height h which is illustrated here. Accordingly, the height H of the grooves 311 may also be different according to the height h by which the nozzle plates 111 protrude from the nozzle unit 110.

The absorber 310 includes a space unit 312, which becomes a closed space when the absorber 310 encloses the nozzle plates 111. The reason why the absorber 310 encloses the nozzle plates 111 and seals the nozzle plates from their surroundings is to absorb and remove foreign matter that remains around the nozzle plates using the suction unit 340.

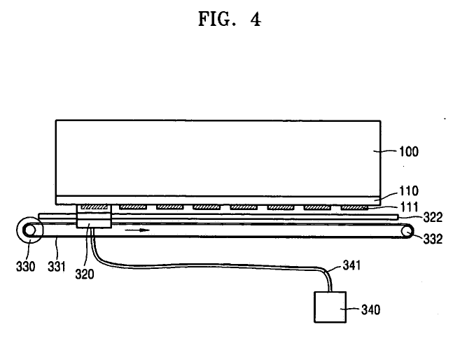

The moving body 320 is slidably installed in a lengthwise direction of the printing head 100 and slides the absorber 310 therein in the lengthwise direction of the printing head 100. The moving body 320 includes supporting units 321 slidably supported by a pair of guiding units 322 on both sides of the moving body 320. A belt 331 is connected to the other two sides of the moving body 320 and is rotatably supported by the driving unit 330 and a supporting roller 332 (FIG. 4).

The driving unit 330 is a motor that rotates the belt 331. As the belt 331 rotates, the moving body 320 slides in the lengthwise direction of the printing head 100, thereby sliding the absorber 310 in the lengthwise direction of the printing head 100.

An elastic unit 313 is interposed between the absorber 310 and the moving body 320 and elastically biases the absorber 310 upward toward the moving body 320. Therefore, the absorber 310 is elastically biased upward by the elastic unit to be pressed against the nozzle plates 111.

The suction unit 340 is connected to the absorber 310 by a tube 341. When the absorber 310 surrounds the nozzle plates 111, the suction unit 340 absorbs and removes foreign matter that remains around the nozzle plates 111. The tube 341 may penetrate the moving body 320 and the absorber 310. However, the tube 341 may also be installed in a different configuration if desired.

To absorb foreign matter that remains around the nozzle plates 111 using the suction unit 340, the absorber 310 must seal the nozzle plates 111. The absorber 310 may seal the nozzle plates 111 using an additional sealing unit, such as a gasket.

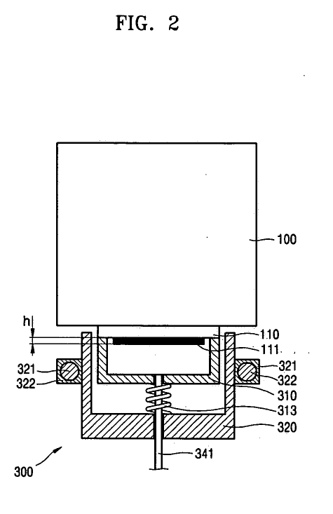

The operation of the cleaning device according to the present invention will now be described with reference to the drawings. Referring to FIGS. 2 and 4, an image is formed on a sheet of paper using the printing head 100. Then, the driving unit 330 rotates the belt 331 to clean the nozzle plates 111.

The moving body 320 slides in the lengthwise direction of the printing head 100 and the absorber 310 moves accordingly. The absorber 320 encloses and seals a first nozzle plate 111 on the left in FIG. 4. The suction unit 340 absorbs and removes foreign matter that remains around the first nozzle plate 111 through the tube 341. The foreign matter removed from the first nozzle plate 111 is stored in the absorber 310 or in an additional storing device. The moving body 320 moves to a second nozzle plate 111 and performs the same operation described above to clean the nozzle unit 110.

As described above, an inkjet printer according to the present invention uses a cleaning device that absorbs and removes foreign matter from nozzle plates without directly contacting the nozzle plates. Therefore, foreign matter removed from one nozzle plate does not contaminate another nozzle plate.

While the invention has been shown and described with reference to certain embodiments thereof, it will be understood by those skilled in the art that various changes in form and details may be made therein without departing from the spirit and scope of the invention as defined by the appended claims.

What is claimed is:

1. An inkjet printer comprising:
a printing head having a length corresponding to a width of a sheet of paper and comprising a nozzle unit having a plurality of nozzle plates; and
a cleaning device for sliding in a lengthwise direction of the printing head and forcibly absorbing and removing foreign matter stuck to the nozzle plates.

2. The inkjet printer of claim 1, wherein the cleaning device comprises:
an absorber enclosing and sealing the nozzle plates;
a moving body surrounding the absorber and comprising supporting units slidably supported by a pair of guiding units on both sides of the moving body; and
a suction unit connected to the absorber and absorbing the foreign matter stuck to the nozzle plates.

3. The inkjet printer of claim 2, wherein the cleaning device further comprises:
an elastic unit that elastically biases the absorber upward toward the moving body.

4. The inkjet printer of claim 2, further comprising:
a driving unit that moves the moving body in the lengthwise direction of the printing head.

5. The inkjet printer of claim 4, wherein the driving unit comprises:
a belt connected to the moving body; and
a motor rotating the belt.

6. The inkjet printer of claim 2, wherein
the cleaning unit is connected to the suction unit by a tube.

7. The inkjet printer of claim 2, wherein
grooves are formed on both sides of the cleaning unit in a height equal to a height by which the nozzle plates protrude, and the nozzle plates are inserted into the cleaning unit.

8. A cleaning device for an inkjet printer that has a printing head having a length corresponding to a width of a sheet of paper and a nozzle unit having a plurality of nozzle plates, the cleaning device comprising:
an absorber that encloses and seals the nozzle plates;
a moving body that surrounds the absorber;
a suction unit connected to the absorber absorbing foreign matter stuck to the nozzle plates; and
a driving unit that moves the moving body in the lengthwise direction of the printing head.

9. A cleaning device for an inkjet printer according to claim 8, wherein
the moving body has a pair of supporting units slidably supported by a pair of guiding units on both sides of the moving body

10. A cleaning device for an inkjet printer according to claim 8, wherein the cleaning device further comprises:
an elastic unit that elastically biases the absorber upward toward the moving body.

11. A cleaning device for an inkjet printer according to claim 8, wherein the driving unit comprises:
a belt connected to the moving body; and
a motor rotating the belt.

12. A cleaning device for an inkjet printer according to claim 8, wherein
the absorber is connected to the suction unit by a tube.

13. A cleaning device for an inkjet printer according to claim 8, wherein
the nozzle plates protrude at a height h from the nozzle unit, and
the absorber has grooves on both sides that are equal to the height h that the nozzle plates protrude from the nozzle unit.

14. A cleaning device for an inkjet printer according to claim 13, wherein
the nozzle plates are inserted into the cleaning unit.

15. An inkjet printer comprising:
a printing head having a length corresponding to a width of a sheet of paper, the printing head having a nozzle unit with a plurality of nozzle plates that protrude from the nozzle unit;
an absorber enclosing and sealing the nozzle plates;
a moving body surrounding the absorber, the moving body having supporting units that are slidably supported by a pair of guiding units located on both sides of the moving body, the moving body sliding in a lengthwise direction of the printing head; and
a suction unit connected to the absorber, the suction unit removing foreign matter from the nozzle plates.

16. The inkjet printer of claim 15, wherein the cleaning device further comprises:
an elastic unit that elastically biases the absorber toward the moving body.

17. The inkjet printer of claim 15, further comprising:
a driving unit for moving the moving body.

18. The inkjet printer of claim 17, wherein the driving unit comprises:
a belt connected to the moving body; and
a motor rotating the belt.

19. The inkjet printer of claim 15, wherein
the absorber is connected to the suction unit by a tube.

20. The inkjet printer of claim 15, wherein
the nozzle plates protrude at a height h from the nozzle unit, and
the absorber has grooves on both sides that are equal to the height h that the nozzle plates protrude from the nozzle unit.
